(19) United States
(12) Patent Application Publication
(10) Pub. No.: US 2012/0290536 A1
(43) Pub. Date: Nov. 15, 2012

(54) SYSTEM FOR IMPROVED RECORD CONSISTENCY AND AVAILABILITY

(75) Inventor: Jack Kreindler, Greater London (GB)

(73) Assignee: Geniedb Inc., San Juan Capistrano (CA)

(21) Appl. No.: 13/512,015

(22) PCT Filed: Nov. 25, 2010
(86) PCT No.: PCT/IB2010/055436

§ 371 Date: May 24, 2012

(30) Foreign Application Priority Data
Nov. 25, 2009 (GB) 0920644.2

(51) Int. Cl. G06F 17/30

(52) U.S. Cl. 707/634; 707/E17.005

(57) ABSTRACT

A method, apparatus, and article of manufacture for providing a globally consistent view of the state of a set of records replicated to multiple servers. Updates to the records are replicated synchronously to a single server chosen by hashing the identifier of the record, known as the ‘responsible server’ for that record, then asynchronously to all the other servers. Reads are performed on the responsible server for the desired record if it is available; otherwise, any other server can provide a possibly slightly out-of-date version of the record.

The present invention generally relates to computer-implemented systems for managing a number of records replicated across a set of servers connected by a network, such as a database, distributed cache, an intermediate state of a distributed algorithm, or any other system that uses replicated state. In particular, it relates to a method for handling reads and updates to this replicated state that provides improved global consistency and availability.

Current distributed data storage systems tend to employ one of two techniques.

‘Replication’ consists of storing multiple copies of the same data on different servers. This provides fault tolerance, as all the data lost on a failed server will still be available on another server, and it provides a system-wide read throughput (i.e. the number of records being read simultaneously by the multitude of clients) that can be increased simply by adding more servers; however, it introduces the problem of consistency, as the act of making the same update on every server holding a replica of the data being updated takes time, leading to different servers having different versions of the record while the update is in progress. One solution to this is ‘synchronous replication’, where the update operation does not return success until every server has been updated; this provides a guarantee that, once the update has completed, every server will see the same new state. However, during such an update operation, different servers may still see different states, and the update operation itself becomes unacceptably slow as the number of servers rises. In the event of network problems preventing communication with one or more servers, the update operation may take an unbounded amount of time.

‘Pure distribution’ consists of splitting the data set, and storing part of it on each server. This provides improved throughput, as the load of read and update operations is spread across the servers, and provides consistency, as every record has precisely one server that carries the most recent version of it. However, it does not provide fault tolerance, and is prone to performance bottlenecks if the distribution of load across records is not uniform, as all accesses to any one particular record have to be handled by one server.

Many existing systems combine the two by distributing records to small groups of servers called ‘shards’, where the record is replicated to all servers within the shard. Potentially, a server may belong to more than one shard. At one extreme there may be a static list of shards in the system, and each record is mapped to a shard by hashing the record ID; at the other extreme, each record may be mapped to a shard of servers by picking a number of servers from the hash of the record ID, independently, so that each record potentially has its own shard. This approach provides high availability due to replication, and goes some way to blending the performance trade-offs of the two approaches. However, this approach introduces increased complexity and suffers from the same consistency issues with replication.

Thus, there is a need for a system with the high availability of replication but without the consistency issues. The present aspect seeks to solve these and other problems, as discussed further herein.

### SUMMARY OF THE INVENTION

An aspect of the present invention provides a record storage system comprising; two or more data stores, each data store comprising a record set that is substantially a replica of the record set stored by each of the other data store(s), each record having one of the data stores as a primary data store, and each record having record characteristics including a unique record identity, a first client configured to, in response to receiving a record update request, request an operation on a record of the primary data store and subsequently request an operation on the corresponding record(s) of the other data store(s).

Another aspect of the invention provides a method for handling data in a database system comprising two or more servers and a client, each data server storing a respective data set comprising a plurality of records that is substantially a replica of the data set stored by the other server(s), and the system being configured such that for each of the records one of the servers is a primary data store for that record; the method comprising performing a write operation by: receiving at the client an instruction to update a record; determining at the client which one of the servers is the primary data store for that record; and if that one of the servers is accessible to the client, transmitting a unicast message from the client to only that one of the servers instructing the server to update the record, and subsequently propagating that update to the other server(s) by transmitting a message from that one of the servers to the other server(s); and if that one of the servers is not accessible to the client, transmitting a multicast message from the client to all of the servers instructing the servers to update the record.

### DESCRIPTION OF THE DRAWINGS

The present invention will now be described by way of example with reference to the accompanying drawings, in which:

FIG. 1 shows a typical aspect of the records storage system of the present invention.

FIG. 2 shows an aspect of the invention comprising two clients systems, two consistency servers and three replica servers.

### DETAILED DESCRIPTION

Described herein is a technique for implementing and taking advantage of a two level trust system in a data storage network. The two levels of trust comprise at least one ‘consistency’ data store, or ‘primary’ data store and at least one ‘replica’ data store. The primary and replica data stores contain substantially duplicate records but the characteristics of the primary and replica data stores are different. In a preferred aspect of the invention, the primary store will have the most current version of a record, or not have it at all. It could lose it due to system failure, as it only stores one copy. Furthermore, certain records may be purged from the primary data store in order to conserve limited space on the primary data store. In this aspect, the at least one replica data store collectively stores multiple copies of the records and so the records are stored more reliably. However, the replica record copies may not be consistent between the primary and replica data stores and across the replica data stores if they are in the process of being updated. The following table describes typical advantages and disadvantages of the data store types.

| Data Store | Advantages | Disadvantages |
|---|---|---|
| Primary | Typically the latest version of | Records may be lost in |
| ‘consistency’ | the record | a system failure. |
| data | | |
| store | | |
| ‘Replica’ | Only loses records in | May not reflect latest |
| data | catastrophic failure cases | version of the record for |
| store | | some time after a |
| | | change is requested |

This arrangement allows the client device to make a choice about which data store to access. In the preferred aspect of the invention, the client device chooses to use the primary data store to get the most recent version, but may have to fall back to the replica if the primary store does not have it (or the primary store is broken/unavailable).

In one aspect of the invention, the primary store has lower latency when accessed by the client device, but the replica store has higher read throughput. Therefore, in order to avoid large amounts of traffic on the primary store, the client device may chose to access the replica store in preference to the primary store.

In yet another aspect of the invention, in which a record is required quickly and it is not essential that it is the very latest version, the replica data store, which may be local to the client device, may be accessed for the record. i.e. if the records comprise computer game high scores, the most up-to-date version of the high score would not necessarily be needed for the purposes of a local high score table. However, if it is essential that the record obtained is the most recent version, regardless of cost or delay, the primary data store should be accessed for a copy of the record, i.e. if the records comprise frequently updated missile target co-ordinates for an imminently to be launched missile.

In order to implement the two levels of trust, the records of the data stores may be updated in a different manner to one another. The records of the primary data store must be updated in a manner that ensures that the primary data store always has the most current version of the record. For example, the primary data store may be updated in a synchronous manner by a client device. The corresponding record of the replica data store may be updated in a manner which conserves bandwidth, CPU time, or some other valuable resource, such that the corresponding record is updated either with a lesser degree of reliability or at a period of time after the record of the primary store is updated.

### System Architecture

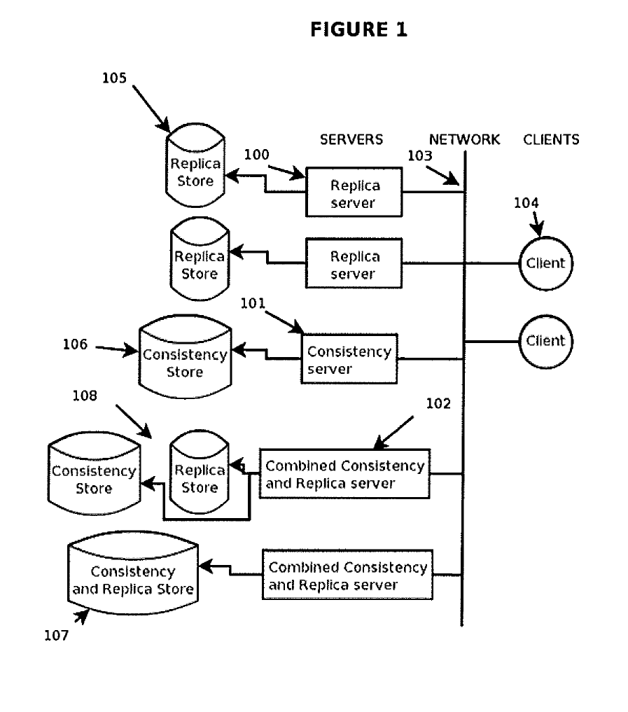

To overcome the limitations of the prior art described above, and to overcome other limitations that will become apparent upon reading and understanding the present specification one aspect of the invention, shown in FIG. 1, provides a method for updating a record replicated onto a set of N replica servers (100), with the assistance of a set of M consistency servers (101) (where the two sets may be disjoint, overlapping, or identical, as it is entirely possible to have combined consistency and replica servers (102)), where the servers are connected to each other and to clients (104) by some form of communications network (103). In particular, the record storage system of one aspect of the invention comprises:

1. A set of one or more replica servers (100) with replica storage (105).

2. A potentially overlapping, disjoint, or identical set of one or more consistency servers (101) with consistency storage (106), configured to perform the method described below for implementing the storage of the most recent versions of records.

3. A client application, running on one of the above servers or on some separate computer (104) and configured to perform the methods described below for updating or reading records, or finding records matching some criteria.

4. A network or other communications medium joining the above servers (103).

### Consistency Server Behaviour

The method for operating as a consistency server (101) according to one aspect of the invention is as follows:

1. If an update request arrives from the network (103), and there is no existing data for that record in the server's consistency store (106), adding the supplied record state to the consistency store (106), then reporting success in a reply message.

2. If an update request arrives from the network (103), and there is a previous state for that record in the server's consistency store (106), overwriting it with the supplied record state in the consistency store (106), then reporting success in a reply message.

3. If a read request arrives from the network (103), and there is data in the server's consistency store (106) for the record with the ID contained in the request, reply with that data.

4. If a read request arrives from the network (103), and there is no data the server's consistency store (106) for the record with the ID contained in the request, reply with a special message stating this fact.

### Configuration Details of Consistency/Replica Servers

As the consistency server (101) only needs to store records in order to provide consistency functions, as the replica servers (100) are responsible for safe persistent storage of the data, the consistency server (101) is not required to persistently store the records. Therefore, for efficiency, the consistency server (101) may (but is not required to) purely store them in volatile memory.

The functions of replica server (100) and consistency server (101) may be isolated, whether the set of replica servers (100) overlaps, is disjoint from, or is identical to the set of consistency servers (101); or, where one or more servers are (or potentially could be) fulfilling both roles at once (102), the consistency store may be the same store used by replica servers to store their replicas (107), or may be separate (108).

### Client Behaviour

The client behaviour according to one aspect of the invention comprising the following steps performed by the client (104):

1. Computing some hash function of the record's unique ID, to obtain the record hash number.

2. Applying a mathematical function to that hash number to produce a number in the range 1 to M, in order to choose a consistency server (101).

3. Synchronously notifying the chosen consistency server of the new state of the record, by sending it a notification of the update over the network, and waiting until a successful acknowledgement is retrieved; if the request times out or is rejected with a network error, then continue this process regardless.

4. Asynchronously sending notification of the change to all the replica servers (100), using some means irrelevant to this invention to deal with server or network failures.

It is required that all applications using the system use the same hash function, and the same list of consistency servers (101) in the same order, so that all applications will consistently choose the same consistency server (101) for the same record.

The corresponding method for deleting a record is to update it using the above method, but to update it to a special sentinel “deleted” value. The consistency server (101) will store this “deleted” state of the record as the current version.

And the corresponding method for reading a record, ensuring the most recent version is available, comprising the following steps performed by the client (104):

1. Computing some hash function of the unique ID of the desired record, to obtain the record hash number

2. Applying a mathematical function to that hash number to produce a number in the range 1 to M, in order to choose a consistency server (101)

3. Sending a request over the network to the chosen consistency server (101) for the most recent version of the desired record

4. If the request returns an error, or times out, then contacting one of the replica servers (100) to ask for the most recent version

5. If the request succeeds and the consistency server (101) has a copy of the requested record, then using the copy returned in the request

6. If the request succeeds but the consistency server (101) has no information about the requested record, then contacting one of the replica servers (100) to ask for the most recent version

Searching without ID

All of the above cover only the case of reading a record when the ID of that record is already known, so that it can be hashed. There is a corresponding method for obtaining records according to some arbitrary criteria:

1. Choose, by some method outside the scope of this invention, a replica server (100)

2. Ask that replica server (100), via whatever communication method is appropriate (103), for a list of the IDs of records matching the criteria, according to the records and their states known to that replica (100)

3. If the request is rejected, or fails due to a network or server failure, then choose a different replica server (100) and return to the previous step

4. For each of the record Ds we have obtained, follow the above procedure for reading a record given its ID to obtain the most recent version of that record. Any that return the “deleted” sentinel value are omitted from the result; any that are found, but their new state means they no longer match the search criteria are likewise omitted; otherwise, the resulting record is returned to the user.

This method will miss newly-created records if the chosen replica server (100) does not yet know of their existence, or that did not match the search criteria but have been recently modified so as to, and the chosen replica server does not yet know of this; but for all records it finds, it will return their consistent state (or omit deleted records).

### Detailed Example Implementation

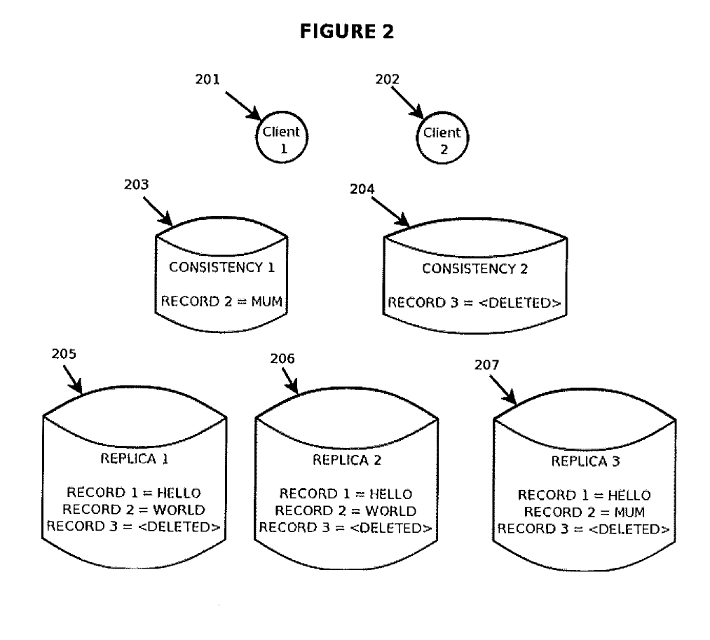

FIG. 2 gives an example of the state of a running system, comprising two clients (201) (202), two consistency servers (203) (204) and three replica servers (205) (206) (207).

As can be seen, the replica servers (205) (206) (207) each hold a copy of the three records in the database, but replica server 3 (207) holds a different state for record 2 than replica servers 1 (205) and 2 (206), as client 1 (201) has just issued an update changing record 2 from ‘WORLD’ to ‘MUM’. It has computed that consistency server 1 (203) is responsible for record 2, so it has sent the new state of the record there before starting to send it to the replica servers.

Should either client choose to retrieve record 2, it would first compute the consistency server responsible for record 2, which is consistency server 1 (203), where it finds the new, correct, state for record 2.

Record 1 has not recently been updated, so its state is consistent across all three replica servers (205) (206) (207); and, therefore, it is not present on the consistency server responsible for it (whichever that might be), as any replica server can be correctly asked for the current value. However, record 3 has been recently deleted, so although replication has completed and it is marked as deleted on all three replica servers (205) (206) (207), its deleted state is also reflected in the consistency server responsible for it, consistency server 2 (204). How long it remains there is irrelevant to this discussion, as long as it remains there for long enough for the replica servers (205) (206) (207) to attain consistency.

### Detailed Description of the Preferred Aspect

In the following description of the preferred aspect, reference is made to a specific aspect in which the invention may be practiced. It is to be understood that other aspects may be utilised and structural changes may be made without departing from the scope of the present invention.

### OVERVIEW

The present aspect, known as “Data Store” or “DS”, comprises a fully replicated database. The replica store is stored on disk in B-Trees, identifying records by their unique IDs, with secondary indices in additional B-Trees. The DS software running on each server is split into client and server parts, communicating by sharing the on-disk replica store and a shared memory region. The client uses TCP connections to the consistency servers, and uses a reliable multicast protocol to asynchronously advertise the update to the replica servers, and handles all reads from replica servers by directly reading the on-disk replica store on the server. A separate executable process embodies the consistency server, which is conventionally but not necessarily executed on the same physical servers as the replica servers; however, future versions of the DS will incorporate the replica server functionality into the DS daemon in order to share replica and consistency stores; but in the current aspect, the consistency server stores records in volatile memory while the replica server stores them on persistent disk.

The client part of the DS software exposes a programming interface to the user's application software, which provides various operations to access the replicated database. The operations of particular interest cover reading individual records with ‘GDSGet’, updating, deleting or inserting records with ‘GDSSet’ and ‘GDSDelete’ (the latter being a wrapper for ‘GDSSet’ that just sets a record to the ‘deleted’ state), and cursor-based access for index searches and full-table scans with ‘GDSMakeTableCursor’, ‘GDSMakeIndexCursor’, ‘GDSCursorGetCurrent’, ‘GDSCursorGetNext’, ‘GDSCursorGetPrev’, and ‘GDSSeekCursor’.

### GDSGet

This function, given the name of a table and the ID of a record in that table, returns the record with that ID in that table, if one exists; or it can return an error if the table does not exist, if there is no such record, or if an internal system error occurs.

The table name and record ID are combined into a single string, and hashed using the FNV1a32 hash described in http://www.isthe.com/chongo/tech/comp/fnv/index.html, which is incorporated by reference herein.

This hash, modulo the number of consistency servers, is used as an index into an array of consistency servers loaded from a configuration file at startup. It is the responsibility of the separate cluster management system to ensure that the same configuration file is available to all servers.

The DS client software maintains a pool of TCP connections to consistency servers, to amortise the cost of opening new TCP connections. If a connection to the chosen consistency server does not already exist in the pool, and that server does not have a “block” in the pool with an expiry timestamp in the future, then a TCP connection is attempted to the consistency server. If the connection attempt fails, then a block is entered into the pool with an expiry timestamp set BACKOFF seconds in the future; if it succeeds, then the connection is placed into the pool. BACKOFF is a configurable parameter.

The selected consistency server is then, over the connection in the pool, sent a request for the record, identified by the table name and record ID. If the request fails due to a server or network error, then the connection is closed, and replaced in the connection pool with a block with an expiry timestamp BACKOFF seconds in the future.

If a record is found and returned successfully, then that is returned to the user.

If no record is found, due to error or the record not being present on the consistency server, then the local replica store is consulted directly. If the record is found there, then as an optimisation, a copy of it is sent to the selected consistency server; as our consistency server stores records in RAM, it is also used as a shared, distributed, cache in front of the relatively high-latency replica store; the found record is also returned to the user. If the record is not found, then a “record was not found” error is returned to the user.

### GDSSet

This function, given the name of a table, a record ID, and a record body, stores the record body in the table with the supplied ID. If there is already a record with that ID in the global database, it is overwritten with the new body; otherwise, a new record is created.

GDSSet starts by computing the FNV1a32 hash of the table name and the record ID, then taking that hash modulo the number of consistency servers in order to choose the same consistency server that GDSGet and other functions would choose for that record ID in that table.

GDSSet then issues an update request to the chosen consistency server, specifying the table name and record ID, and the record body. When a response is received—be it success or failure—it proceeds to issue a reliable multicast to all replica servers containing the new record, before returning to the user. Failure is only signalled if an internal error occurred, or the reliable multicast failed; failure of the write to the consistency server is undesirable—as global consistency will not be preserved in the short term—but non-fatal.

### GDSDelete

It is possible to delete a record by calling GDSSet and asking to set the record to have a NULL body. This NULL body will duly be recorded in the consistency server, and the replica servers, upon receiving the NULL body, will store it into the replica store, in order to record that the record was deleted (as part of their replicating functionality, outside of the scope of this invention, a record of a record's deletion needs to be kept, rather than simply removing all trace of the record having existed).

However, as a convenience, we provide GDSDelete, which accepts a table name and a record ID, and then calls GDSSet with the supplied table name and record ID, and a NULL record body.

### GDSMakeTableCursor

This function, given a table name and a cursor direction, constructs a cursor usable for navigating through multiple records in a given table, ordered by their record IDs. The cursor is a logical marker that points at a given record in the table; if the cursor direction is “forward” (the default) then the cursor starts on the first record; if the direction is “backward” then it starts on the last record. The returned cursor object identifies the table, the direction, and the current record.

### GDSMakeIndexCursor

This function, given a table name, the name of an indexed field, and a cursor direction, constructs a cursor usable for navigating through multiple records in a given table, ordered by the named field. The cursor is a logical marker that points at a given record in the table; if the cursor direction is “forward” (the default) then the cursor starts on the first record; if the direction is “backward” then it starts on the last record. The returned cursor object identifies the table, the direction, the field, and the current record.

### GDSCursorGetCurrent

This function returns the record ID and body of the current record of a supplied cursor. If there is no current record (for example, if a cursor has been created on an empty table), then a suitable error code is returned; otherwise, the record is returned.

In order to provide partial global consistency, this function locates the current record of the cursor in the version of the table in the local replica store. It obtains the record ID from the replica store, and then computes the FNV1a32 hash of the table name and the record ID, then takes that hash modulo the number of consistency servers to choose a consistency server. As usual, it sends a request for the record with that table name and record ID to the consistency server. If it receives a network or server error, then the record read from the local replica store is the “candidate record”. If a record is returned from the replica server, that becomes our “candidate record”.

If the candidate record has a NULL body (eg, is a remnant of a deleted former record), then we advance the cursor in its direction to find the next record in the local replica store, and repeat the above process, until a non-NULL candidate record is found. By this process, a recently deleted record that still exists in the local replica store will, upon consulting the consistency server, be found to have been deleted, and so will automatically be skipped.

When a non-NULL candidate record is found, it is returned to the user. If we reach the end of the table before one is found, then a suitable error code is returned, and there is now no current record in the cursor.

### GDSCursorGetNext

This function advances the cursor to the next record in the table (in the cursor's direction). If there is no next record, it returns a suitable error code. If there is one, it then directly invokes GDSCursorGetCurrent to find out if the new current record still exists, and if not, to continue advancing until it finds one that does exist, or reaches the end of the table. The result of GDSCursorGetCurrent becomes the result of GDSCursorGetNext.

### GDSCursorGetPrev

This function advances the cursor to the previous record in the table (opposite the cursor's direction). If there is no previous record, it returns a suitable error code. Otherwise, it reads the record ID of the previous record, and takes the FNV1a32 hash of the table name and that record ID, then takes that has modulo the number of consistency servers to choose a consistency server; as with GDSCursorGetCurrent it requests the record with that table name and record ID from the consistency server, and if it obtains a successful response, uses that as the candidate record, otherwise uses the record obtained from the local replica store; if that candidate record turns out to have a NULL body it then the cursor is moved in the direction opposite to its normal direction and the process repeated, until we obtain a non-NULL candidate record which we can return, or reach the end of the table, in which case we return a suitable error code.

### GDSSeekCursor

This function moves the cursor to a specified position in the table (or the nearest position, if the required position does not exist). For cursors created with GDSMakeTableCursor, the position is identified by a record ID; for cursors created with GDSMakelndexCursor, the position is identified by a value of the indexed field.

For non-unique indexed fields, there could be more than one record with the specified value, in which case GDSSeekCursor positions the cursor on the first one for forward cursors, or the last one for backward cursors, so that subsequent calls to GDSCursorGetNext will return them all in order.

If there is no record with the specified record ID or value of the indexed field, respectively, then GDSSeekCursor positions the cursor between the last record with a record ID or indexed field that orders below the desired one, and the first record with a record ID or indexed field that orders after the desired one. If there is no record that would sort before or after the requested record, as the position is right at the end of the table, then the current record is the first or last record of the table as appropriate.

All of these operations are performed upon the table as stored in the local replica store, as handling of recently modified or deleted records, in order to provide a consistent view, is only required when records are requested by the user using GDSCursorGet . . . functions.

Some alternative ways of accomplishing the present invention are described. Those skilled in the art will recognise that the invention may be applied to many different architectures of replicated database and distributed consistency cache. Those skilled in the art will recognise that the present invention could be used with any type of replicated database, including but not limited to ones comprised of independent physical servers connected by any form of communication link, or virtual servers, or resources within a computation or storage cloud, multiple instances of the software running independently on the same virtual or physical server, or even logical partitions such as security sandboxes within a single software process.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A record storage system comprising;
two or more data stores, each data store comprising a record set that is substantially a replica of the record set stored by each of the other data store(s), each record having one of the data stores as a primary data store, and each record having record characteristics including a unique record identity,
a first client configured to, in response to receiving a record update request, request an operation on a record of the primary data store and subsequently request an operation on the corresponding record(s) of the other data store(s).

2. The record storage system of claim 1, wherein if the requested operation to be performed on the record is a delete operation, the record is updated to comprise a deleted record value.

3. The record storage system of any preceding claim, the first client being configured to, in response to receiving a record update request:
send a request for the operation to be performed on the record to the primary data store,
await confirmation from the primary data store that the operation has been successfully performed,
subsequent to receiving confirmation from the primary data store that the operation has been successfully performed or subsequent to an error condition being reached in response to the request for the operation, send a request for the operation to be performed on the corresponding record of the second data store,

4. The record storage system of any preceding claim, further comprising;
a second client configured to, in response to receiving a record fetch request comprising characteristics of a desired record including the desired record's unique identity, request the record from the primary data store.

5. The record storage system of claim 4, the second client being configured to:
if the request for the record from the primary data store mode fails to complete due to an error or time out condition being reached, requesting the record from a data store other than the primary data store.

6. The record storage system of claim 5, the second client being further configured to, in response to receiving a record fetch request comprising characteristics of a desired record not including the desired record's unique identity, perform the following steps:
requesting and receiving, from a data store other than the primary data store, a list of unique record identities of records matching the characteristics of the desired record,
requesting and receiving, from the primary data store, each of the records having a unique record identity from the received list of unique record identities,
determining the desired record by filtering all other records received from the primary data store that comprise a deleted record value or do not match the characteristics of the desired record.

7. The record storage system of any preceding claim, wherein the record storage system is such that the latency between requesting and receiving a record from the primary data store is lower than requesting and receiving a record from a data store other than the primary data store.

8. The record storage system of any preceding claim, wherein the primary data store comprises a plurality of partitions, each partition comprising a portion of the record set of the primary data store.

9. The record storage system of claim 8, wherein the partitions of the primary data store are located at disjoint locations.

10. The record storage system of any preceding claim, wherein the identity of the partition of the primary data store storing a record is determined by computing a hash function of the record's unique identity.

11. The record storage system of any preceding claim, wherein the record set of the primary data store is stored non-persistently and the record set(s) of the data store(s) other than the primary data store are stored persistently.

12. The record storage system of claim 11, wherein the record set of the primary data store is stored non-persistently in volatile memory.

13. The record storage system of any preceding claim, further comprising at least one host device configured to host the data stores.

14. The record storage system of claim 13, wherein the at least one host device used to host the primary data store are disjoint from the at least one host device used to host the data store(s) other than the primary data store.

15. The record storage system of claim 13, wherein the data store are hosted on a common host device.

16. A method of handling data in a record storage system comprising two or more data stores, each data store comprising a record set that is substantially a replica of the record set stored by each of the other data store(s), each record having one of the data stores as a primary data store, and each record having record characteristics including a unique record identity,
the method comprising the steps of:
in response to receiving a record update request, request an operation on a record of the primary data store
subsequent to the above step, request an operation on the corresponding record(s) of the other data store(s).

17. A method for handling data in a database system comprising two or more servers and a client, each data server storing a respective data set comprising a plurality of records that is substantially a replica of the data set stored by the other server(s), and the system being configured such that for each of the records one of the servers is a primary data store for that record;
the method comprising performing a write operation by:
receiving at the client an instruction to update a record;
determining at the client which one of the servers is the primary data store for that record; and
if that one of the servers is accessible to the client, transmitting a unicast message from the client to only that one of the servers instructing the server to update the record, and subsequently propagating that update to the other server(s) by transmitting a message from that one of the servers to the other server(s); and
if that one of the servers is not accessible to the client, transmitting a multicast message from the client to all of the servers instructing the servers to update the record.

18. The method of claim 17, the method further comprising performing a read operation by:
receiving at the client an instruction to fetch a record;
determining at the client which one of the servers is the primary data store for that record; and
if that one of the servers is accessible to the client, requesting and subsequently receiving the record from that one of the servers,
if that one of the servers is not accessible to the client, requesting and subsequently receiving the record from the other server(s).

19. A record storage system substantially as described with reference to and as shown in the accompanying figures.

20. A method of handling data in a record storage system substantially as described with reference to and as shown in the accompanying figures.
